(19) United States
(12) Patent Application Publication
(10) Pub. No.: US 2017/0139844 A1
(43) Pub. Date: May 18, 2017

(54) ASYMMETRIC MEMORY

(71) Applicant: SILICON LABORATORIES INC., Austin, TX (US)

(72) Inventors: Paul Ivan Zavalney, Austin, TX (US); Thomas S. David, Austin, TX (US)

(73) Assignee: SILICON LABORATORIES INC., Austin, TX (US)

(21) Appl. No.: 14/943,912

(22) Filed: Nov. 17, 2015

(51) Int. Cl. G06F 12/14

(52) U.S. Cl. CPC G06F 12/1441; G06F 12/145; G06F 2212/1052

(57) ABSTRACT

A computing system includes a central processing unit (CPU) connected to communicate over a bus, a memory configured to have at least three accessible memory storage areas arranged asymmetrically and a memory protection unit (MPU) that receives and controls memory access requests received from the central processing unit and from other processing devices, blocks or processes. The MPU determines, based on an identity of the device, block or process that generated the memory access request, whether to allow access based upon which memory area is being accessed and a type of access being requested. The areas of memory include read/write for secure and non-secure, read/write for secure only, and read for secure and non-secure but write only for secure.

### FIELD OF THE DISCLOSURE

The present disclosure relates generally to memory, and more particularly to a memory configuration and a method of accessing the memory.

### BACKGROUND

With the proliferation of electronic devices and associated capabilities, many every day appliances now include computing devices that have a central processing unit, memory, and communication circuitry that supports a particular operation. Moreover, today's electronics are often paired to one or more networks that, probably, is connected to the World Wide Web or Internet (and its multiple versions). For example, auto electronics, household appliances, stereo and music equipment, home computers, cell phones, disk drives for storing data, media access players, watches, remote controls, digital video recorders, televisions, media players, etc., all include computing processors, memory, and communication circuitry configured to support at least one desired function. Moreover, most of these types of circuitry or applications are further configured to pair with Bluetooth™ and Wi-Fi Access Points. The Access Points, in turn, are connected to the Internet via a modem that communicates with an Internet Service Provider gateway device.

While networking is highly desirable, there are risks and costs. Hacking and malicious programs invade computing devices to steal data, reprogram or control the equipment, or even merely to destroy data in an act of vandalism. Recent news reports are replete with stories of unauthorized access to computing devices and their data. Some recent stories have focused, for example, on the ability of hackers to “hack into” car electronics and control the operation of the car.

The structural configuration of a device may have a limited effect in terms of safety. Even for integrated circuit devices including microprocessors security of the data and programs is an important consideration because of the network characteristics of today's devices and systems. For any such systems, it is important that the processor does not run unauthorized code as this weakens device security. For these reasons, data and computing device security are important issues. Hardware and software designs that inhibit unauthorized access to computing device hardware and data is, therefore, highly desirable.

### BRIEF DESCRIPTION OF THE DRAWINGS

The present disclosure may be better understood, and its numerous features and advantages made apparent to those skilled in the art by referencing the accompanying drawings, in which:

FIG. 1 is a prior art memory structure having symmetric memory access.

FIG. 2 is a partial schematic and partial block diagram that illustrates a computing system with a memory structure configured according to one embodiment.

FIG. 3 is a partial schematic and partial block diagram that illustrates a computing system with a memory structure configured according to one embodiment.

FIG. 4 is a functional block diagram of a memory configured according to one embodiment.

FIG. 5 is a flow chart illustrating a method according to one embodiment.

FIG. 6 is a flow chart illustrating a method for accessing asymmetric memory according to one embodiment.

FIG. 7 is a flow chart illustrating an alternative embodiment for accessing memory.

The use of the same reference symbols in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

Thus, to the maximum extent allowed by law, the scope of the present invention is to be determined by the broadest permissible interpretation of the following claims and their equivalents, and shall not be restricted or limited by the foregoing detailed description.

### DETAILED DESCRIPTION

FIG. 1 is a prior art memory structure having symmetric memory access. A memory 10 includes two memory areas. A first memory area shown generally at 12 is a memory area that ranges from address 0 to address m. A second memory area shown generally at 14 is a memory area that ranges from address n to address z. The first memory area 12 is one that only secure devices and processes may access for read and write operations. The second memory area 14 is one that both secure and un-secure devices and processes may access for read and write operations. Each area defined in memory 10 supports that read and write operations. The difference between the two areas relates to whether unsecure devices and processes may access that memory area.

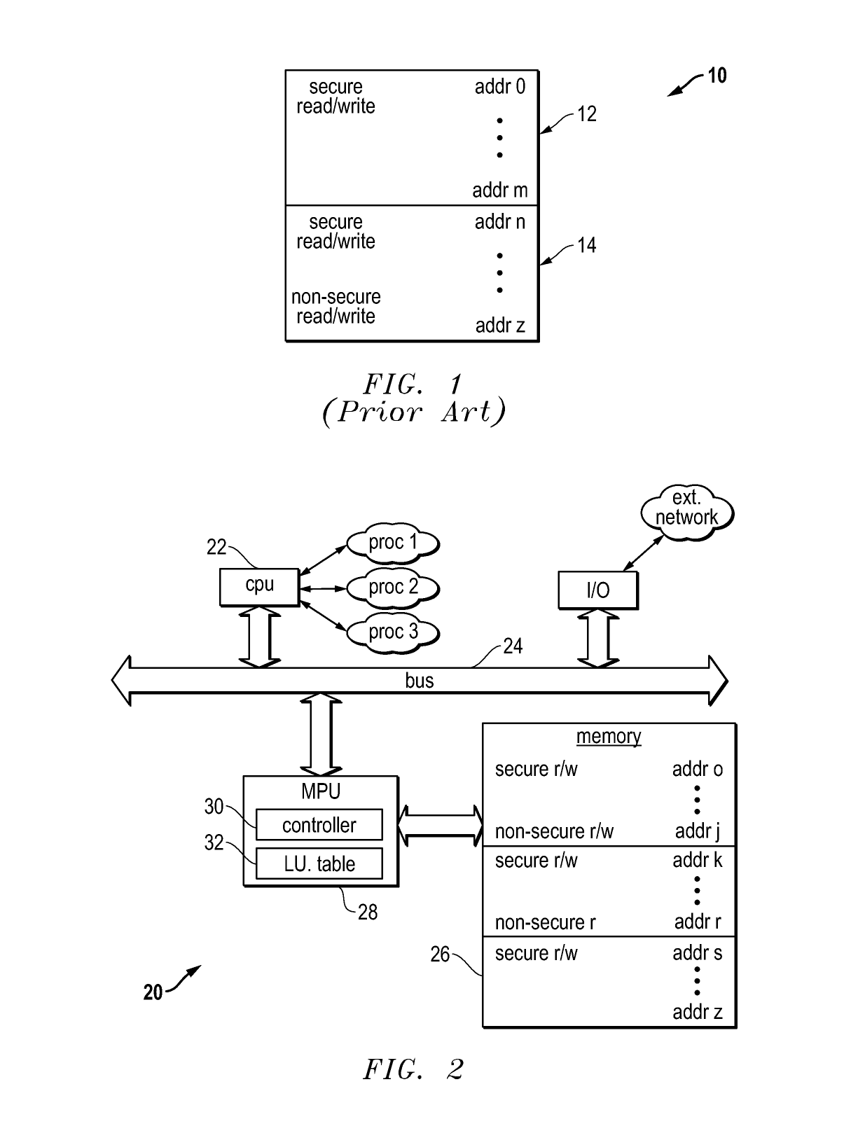

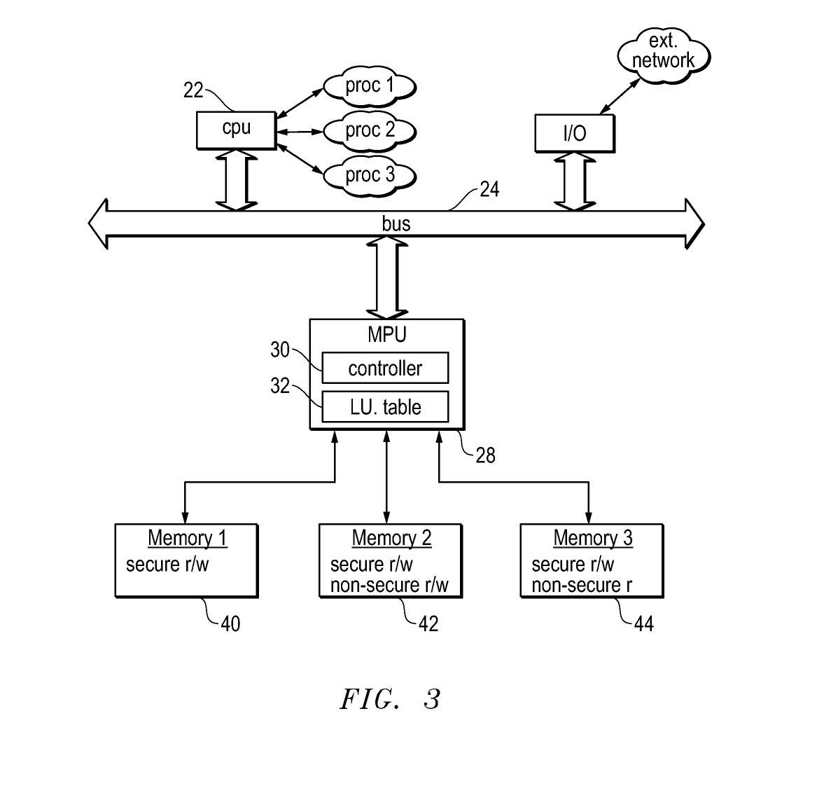

FIG. 2 is a partial schematic and partial block diagram that illustrates a computing system with a memory structure configured according to one embodiment. A computing system 20 includes a CPU 22 that communicates over a bus 24 to retrieve instructions and data stored in a memory 26. Access to memory 26 is controlled by memory protection unit (MPU) 28. MPU 28 includes a controller 30 and a look-up table 32. MPU 28 communicates with processor 22 via bus 24 and with memory 26 via a direct connection or dedicated bus. An input/output interface 24 is also connected to bus 24 to allow computing system 20 to communicate with external networks, systems and devices via wired or wireless communication protocols and physical channels.

Continuing to examine FIG. 2, it should be understood that the explanation regarding memory access is being kept simple and in terms of physical addresses. There are many different accessing schemes including the use of virtual addressing schemes, relative addressing schemes, etc. For example, addressed memory systems use addresses to select memory cells that are being read or written to. Associative memory contemplates the use of content addressable memories. Associative memory is used in cache memory banks in many applications. Sequential memory access systems access memory relative to an offset from a current position. Notwithstanding these different addressing and accessing schemes, they involve memory access to specific areas of memory or ranges of memory. Moreover, the memory access requests may be by the CPU of the device or, if direct memory access is supported, the memory access may be received from another device via, for example, an input/output interface connected to the same bus that the memory (by way of a memory protection unit) is connected. All of these access types are symmetric meaning read and write access is always allowed if a device is allowed access to a region of memory.

In one form, a computing system as described for an embodiment herein includes a CPU, a communication bus, at least one memory, and a memory protection unit (MPU). The memory generally includes at least three areas of memory. A first area is only to be accessed for read and write operation by a block or source having a secure identifier. A second area may be accessed for read and write operations by any block or source without regard to a security identifier meaning blocks and sources with secure and non-secure identifiers may have access for read and write operations. A third area is an asymmetric area in which only blocks or sources having a secure identifier may write, but all blocks and sources including those with non-secure identifiers may have access to read. One aspect of the embodiment is that a secure process may write data to the third and asymmetric area to allow a non-secure block or process to access and read the data but not write (or change) the data. For example, a need exists to run programs from unsecure sources in a manner that will not interfere, tamper, adjust, or maliciously or accidently alter any existing secure processes. In some cases, unsecure processes must interact with secure processes without compromising security. The memory structures of the present embodiments support such access because such a program from an unsecure source could, for example, access a memory location to retrieve data or instructions without being able to change the data or instructions from that or other locations for which only secure processes and sources are allowed access.

Thus, as may be seen from FIG. 2, memory 26 includes a first area defined by a range of addresses, shown here as address 0 to address j, a second defined area that ranges from address k to address r, and a third defined area that ranges from address s to address z. The first area is an area that is designated to allow devices, blocks and processes with a secure or unsecure security access designation or identifier access to read and write. The second area is an area that is designated to allow devices, blocks and processes only with a secure security access designation or identifier access to read and write. Devices, blocks and processes with an un-secure secure security access designation are not given access either to read or write. The third area is an area that is designated to allow devices, blocks and processes only with a secure security access designation or identifier access to read and write while devices, blocks and processes with an un-secure security access designation or identifier are allowed access to read but not to write.

In operation, when a device, block or process generates a memory access request either directly or via CPU 22, MPU 28 receives the access request. Controller 30 of MPU 28 produces an ID or identifier of the device, block or process that generated the memory access request to determine, from lookup table 32 (or from communicating with an algorithm) the security access designation for the device, block or process. Accordingly, access will be granted or denied based on at least at least one of the following factors:
a) Which of the three defined areas of memory is to be accessed;
b) Whether the request is from a secure or a non-secure processing device, block or process; and
c) The type of access being requested.

If the area of memory to be accessed is the first area that allows a secure and un-secure device, block or process to read or write, access is granted without requiring evaluation of b) and c). If the area of memory to be accessed is the second area that only allows a secure device, block or process to read or write, access is granted only if the source has a secure access designation. Accordingly, for this case, both a) and b) must be evaluated. If the area of memory to be accessed is the third area that allow devices, blocks and processes only with a secure security access designation or identifier access to read and write while devices, blocks and processes with an un-secure security access designation or identifier are only allowed to read, then a), b) and c) must be evaluated prior to determining whether the access requested may be granted.

FIG. 3 is a partial schematic and partial block diagram that illustrates a computing system with a memory structure configured according to one embodiment. A computing system 20 includes a CPU 22 that communicates over a bus 24 to retrieve instructions and data stored in a memory 40, 42 or 44. Access to memory 40, 42 or 44 is controlled by MPU 28. MPU 28 includes controller 30 and look-up table 32. MPU 28 communicates with processor 22 via bus 24 and with memory 40, 42 or 44 via a direct connection or dedicated bus. An input/output interface 24 is also connected to bus 24 to allow computing system 20 to communicate with external networks, systems and devices via wired or wireless communication protocols and physical channels.

In one form, a computing system as described for an embodiment herein includes a CPU, a communication bus, at least one memory, and a memory protection unit (MPU). The memory here generally includes at least two distinct memories having differing access rights. In the described embodiment, a first memory 40 is only to be accessed for read and write operations by a block or source having a secure identifier. A second memory 42 may be accessed for read and write operations by any block or source without regard to a security identifier. Stated differently, devices, blocks and sources with secure and non-secure identifiers may have access for read and write operations. A third memory 44 is an asymmetric memory in which only devices, blocks or sources having a secure identifier may write, but all blocks and sources including those with non-secure identifiers may have access to read. One aspect of the embodiment is that a secure process may write data to the third and asymmetric memory 44 to allow a non-secure block or process to access and read the data but not write (or change) the data.

In operation, when a device, block or process generates a memory access request either directly or via CPU 22, MPU 28 receives the access request. Controller 30 of MPU 28 produces an ID or identifier of the device, block or process that generated the memory access request to determine, from lookup table 32 the security access designation for the requesting device, block or process. Accordingly, access will be granted or denied based on at least at least one of the following factors:
a) Which of the three defined memories is to be accessed;
b) Whether the request is from a secure or a non-secure processing device, block or process; and
c) The type of access being requested.

If the memory to be accessed is the first memory that allows a secure and un-secure device, block or process to read or write, access is granted without requiring evaluation of b) and c). If the memory to be accessed is the second memory that only allows a secure device, block or process to read or write, access is granted only if the source has a secure access designation. Accordingly, for this case, both a) and b) must be evaluated. If the memory to be accessed is the third memory that allow devices, blocks and processes only with a secure security access designation or identifier access to read and write while devices, blocks and processes with an un-secure security access designation or identifier are only allowed the read, then a), b) and c) must be evaluated prior to determining whether the access requested may be granted.

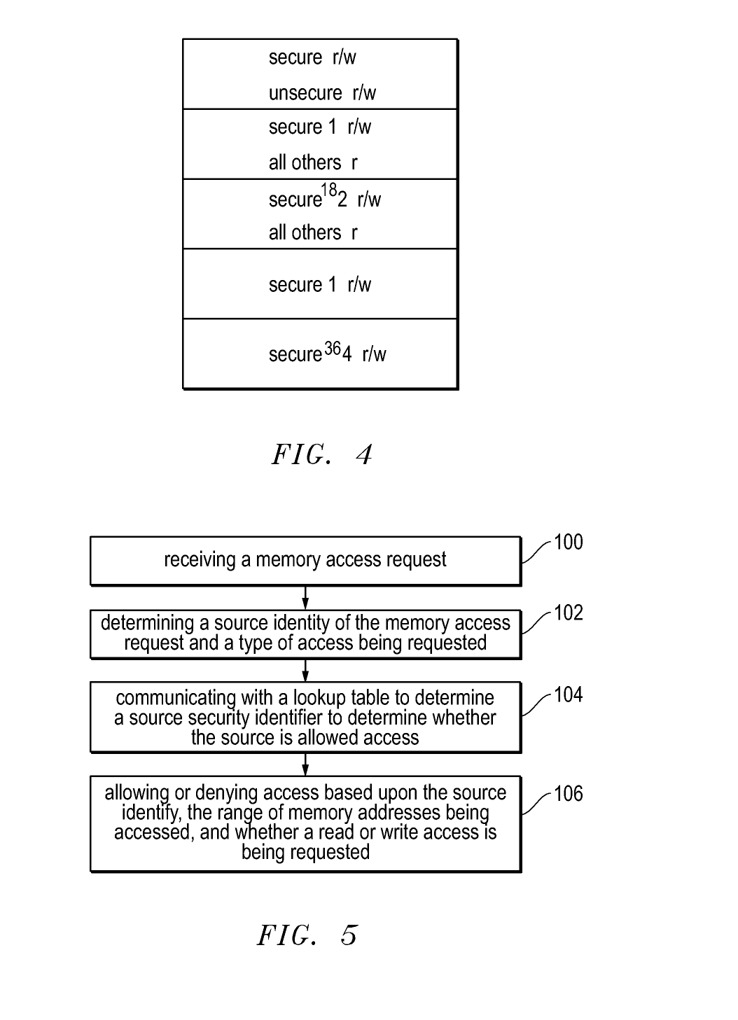

FIG. 4 is a functional block diagram of a memory configured according to one embodiment. The embodiment of FIG. 4 illustrates 5 areas of memory though it should be understood that the principles demonstrated in relation to FIG. 4 may be applied to memory configurations having differing numbers of memory areas. As may be seen, the memory of FIG. 4 has the following memory areas:
1) Secure read/write, unsecure read/write allowed;
2) Secure 1 read/write, all others read only;
3) Secure 1 and secure 2 read/write, all others read only;
4) Secure 1 only read/write; and
5) Secure 3 and 4 only read/write.

Thus, it may be seen that memory is more highly partitioned to better control what devices, blocks or processes may access a given area of memory for either read or write operations. It should be understood that a plurality of IDs or a group of IDs may be represented by a designation such as, for example, “secure 2”. For example, devices, blocks and processes with a secure 1 designation may be allowed to access operational software instructions (e.g., kernel type instructions) while secure 2-4 designation may be allowed for application programs being hosted and stored in memory. One aspect of the embodiment of FIG. 4 is that multiple areas may be defined for devices, blocks and processes having secure designations with tiered or even mutually exclusive access restrictions. Further, access may be symmetric or asymmetric (some have full access and others have read only access). It should be understood that the access in relation to the security designations illustrate ways that memory may be arranged but that the actual access rules may vary and still be within the scope of the disclosure.

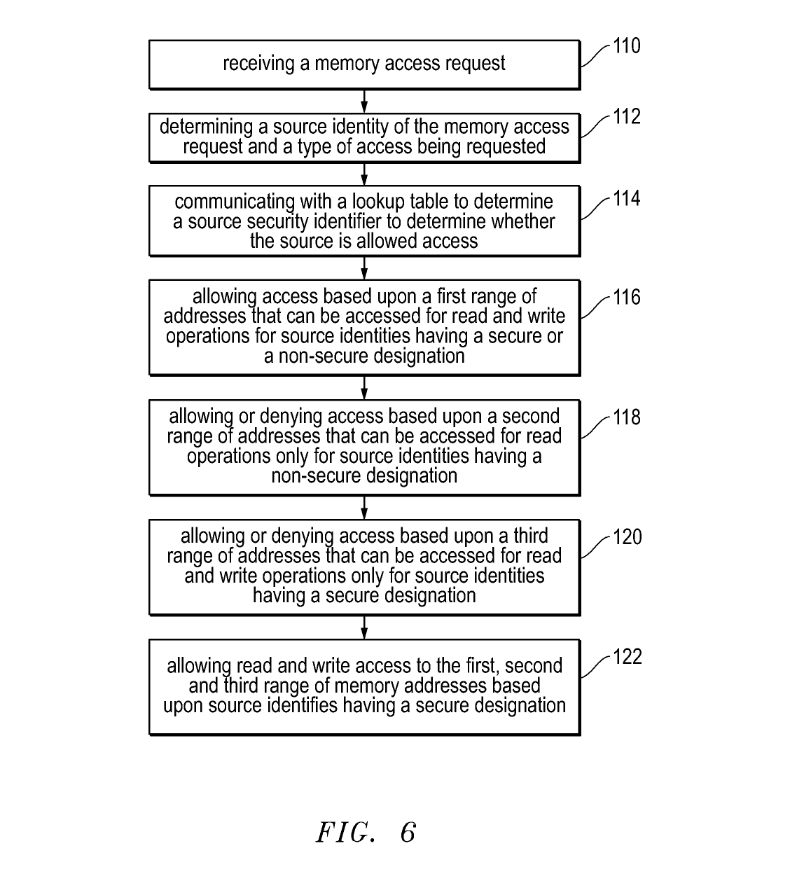

FIG. 5 is a flow chart illustrating a method according to one embodiment. The method commences with a memory controller receiving a memory access request from a device, block or process (100) and then determining a source identity of the memory access request and a type of access being requested (102). Any known form of identifying a device, block or process that is implemented may be used. The method further includes communicating with a lookup table to determine a source security identifier to determine whether the source is allowed access (104) and subsequently allowing or denying access based upon the source identify, the range of memory addresses being accessed, and whether a read or write access is being requested (106).

As described before, a memory structure includes an asymmetric arrangement with respect to read and write operations for the memory. A first area is one in which read and write operations are allowed for any device, block or process regardless of whether the device, block or process has a secure or un-secure security designation.

FIG. 6 is a flow chart illustrating a method for accessing asymmetric memory according to one embodiment. The method commences with a memory access controller receiving a memory access request (110). The method further includes determining a source identity of the device, block or process that generated the memory access request and a type of access being requested (112). The method further includes the controller communicating with a lookup table to determine a source security identifier to determine whether the source is allowed access (114). In the described embodiment, the method includes allowing access based upon a first range of addresses that can be accessed for read and write operations for source identities having a secure or a non-secure designation (116). The method further includes allowing or denying access based upon a second range of addresses that can be accessed for read operations only for source identities having a non-secure designation (118) and allowing or denying access based upon a third range of addresses that can be accessed for read and write operations only for source identities having a secure designation (120). Finally, the method includes allowing read and write access to the first, second and third range of memory addresses based upon source identities having a secure designation (122)

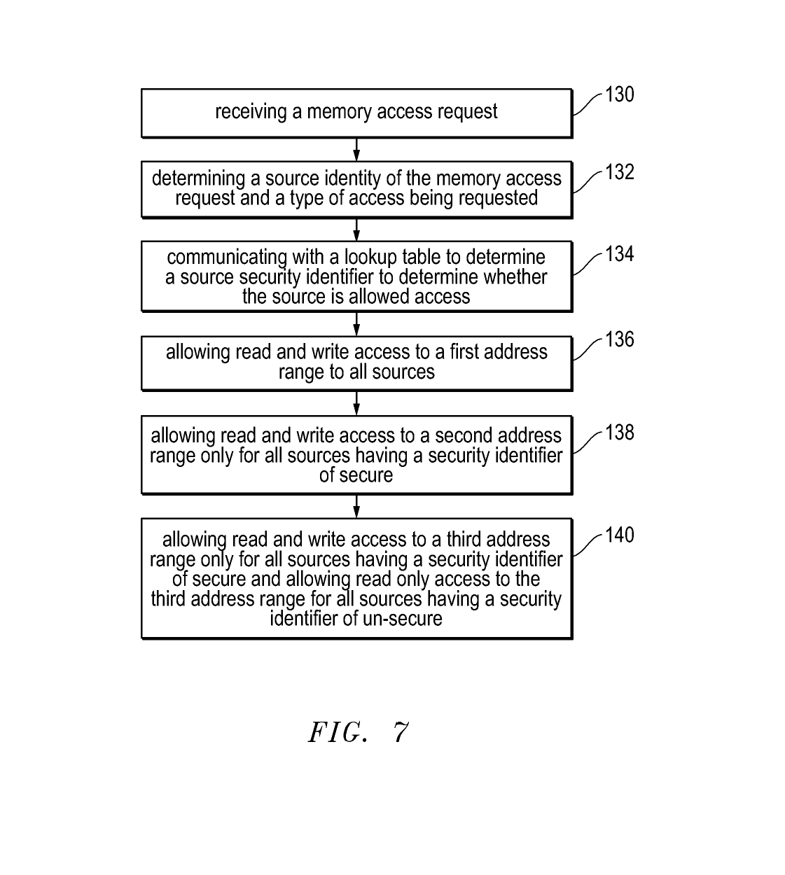

FIG. 7 is a flow chart illustrating an alternative embodiment for accessing memory. The method commences with a memory controller receiving a memory access request (130) and determining a source identity of the memory access request and a type of access being requested (132). The method further includes the controller communicating with a lookup table to determine a source security identifier to determine whether the source is allowed access (134). The method thus includes determine to allow read and write access to a first address range to all sources (136) regardless of whether the device, block or process has a security designation that is secure or un-secure. The method also includes allowing read and write access to a second address range only for all sources having a security identifier of secure (138). Any device, block or process not having a secure designation is not allowed to either read or write any memory cell or register within this first address range.

The method also includes allowing read and write access to a third address range only for all sources having a security identifier of secure and allowing read only access to the third address range for all sources having a security identifier of un-secure (140). Here, a device, block or process having an un-secure security designation may read but may not write to the memory cells or registers having this third range of addresses.

A memory access system for a computing system has been described that operates using a memory controller for controlling access to memory. The above-disclosed subject matter is to be considered illustrative, and not restrictive, and the appended claims are intended to cover all such modifications, enhancements, and other embodiments that fall within the true scope of the claims. For example, an MPU can be built according to the principles of described above for an arbitrary number N different security regions and M secure sources. Sources themselves may have multiple levels of security prioritization allowing access to various number of pre-configured security regions. Moreover, an MPU can provide tiers of security regions and sources to match based on level prioritize. For example, a secure source designated with security level 3 can have read/write access to any region with security level designation greater than 3, can read from any region with security level equal to 3 but cannot write to any region with security level equal to 3, and cannot access any region with security level less than 3. Any algorithm, method, or calculation can be employed to determine access to various asymmetrical and symmetrical regions. Additional modifications may include dynamic re-allocation of memory regions by processes with secure access to any region that it can have full access.

What is claimed is:

1. A computing system, comprising:
a central processing unit (CPU) connected to communicate over a bus;
a memory configured to have at least three accessible memory storage areas configured asymmetrically;
a memory protection unit (MPU) that receives and controls memory access requests received from the central processing unit and from other processing devices, blocks or processes and determines, based on an identity of the device, block or process that generated the memory access request, and determines whether to allow access based upon which memory area is being accessed and a type of access being requested.

2. The computing system of claim 1 wherein the at least three accessible memory storage areas include:
a first memory area that is a secure only read and write area;
a second memory area that is a secure and a non-secure read and write area; and
a third memory area that is secure and non-secure read area and a secure only write area.

3. The computing system of claim 2 wherein the MPU evaluates every memory access request and allows or denies the memory access requests based on, for each request, whether the request is from a non-secure processing block or process and which of the three defined areas of memory is to be accessed.

4. The computing system of claim 1 wherein the MPU includes a controller and a lookup table.

5. The computing system of claim 4 wherein the controller uses a device, block or process identifier to retrieve a security identifier from the lookup table or algorithm to determine whether to allow the access request.

6. A memory access system, comprising:
a memory controller connected to receive memory access requests, wherein the memory controller controls access to:
a first memory that only secure devices, blocks or processes are allowed access to read and write;
a second memory that secure and non-secure devices, blocks or processes are allowed access to read and write; and
a third memory that secure and non-secure devices, blocks or processes are allowed access to read and only secure devices, blocks or processes are allowed access to write;
a lookup table that maps memory access request device, block or process source identifiers with a security access designation; and
wherein the memory controller is configured to communicate with the lookup table or with an algorithm to evaluate and allow or deny access to the first, second or third memory based on at least two of the following:
whether a read operation or a write operation is to be performed;
which of the first, second and third memories is to be accessed; and
the security access designation for the device, block or process that generated the memory access request.

7. The memory access system of claim 6 wherein the memory controller allows read and write operations to the first, second or third memory if the source identifier has a secure designation.

8. The memory access system of claim 6 wherein the memory controller allows all read and write operations for the second memory.

9. The memory access system of claim 6 wherein the memory controller allows read only operations if the source identifier of the device, block or process requesting access has a non-secure designation for the third memory that is designated for non-secure read operations and secure only write operations.

10. The memory access system of claim 6 wherein the first, second and third memories are different memory areas of a memory.

11. The memory access system of claim 6 wherein the first, second and third memories comprise at least two different memory devices.

12. The memory access system of claim 6 wherein the first, second and third memories are separate memory devices.

13. A method performed by a memory controller for controlling access to memory, comprising:
receiving a memory access request;
determining a source identity of the memory access request and a type of access being requested in the memory access request; and
communicating with a lookup table that maps source identities to secure designations to determine if the source is allowed access to a range of memory addresses being accessed and, if so, whether access is allowed for the type of access being requested.

14. The method of claim 13 further including allowing or denying access based upon the source identify, the range of memory addresses being accessed, and whether a read or write access is being requested.

15. The method of claim 13 further including defining a first range of addresses that can be accessed for read and write operations for source identities having a secure or a non-secure designation.

16. The method of claim 15 further including defining a second range of addresses that can be accessed for read operations only for source identities having a non-secure designation.

17. The method of claim 16 further including defining a third range of addresses that can be accessed for read and write operations only if the source identity has a secure designation.

18. The method of claim 13 wherein access requests having a secure designation are allowed read and write access to the first, second and third range of memory addresses.

19. The method of claim 13 wherein a plurality of secure designations are defined for a corresponding number of secure only memory address ranges for read operations.

20. The method of claim 13 wherein a plurality of secure designations are defined for a corresponding number of secure only memory address ranges for write operations.
